(19) United States
(12) Patent Application Publication
(10) Pub. No.: US 2010/0315405 A1
(43) Pub. Date: Dec. 16, 2010

(54) DRIVING CIRCUIT FOR LIQUID CRYSTAL DISPLAY DEVICE

(76) Inventor: Noriyuki Tanaka, Osaka (JP)

Correspondence Address: HARNESS, DICKEY & PIERCE, P.L.C., P.O. BOX 8910, RESTON, VA, 20195, US

(21) Appl. No.: 12/735,713

(22) PCT Filed: Jan. 20, 2009
(86) PCT No.: PCT/JP2009/050710

§ 371 Date: Aug. 11, 2010

(30) Foreign Application Priority Data
Apr. 16, 2008 (JP) 2008-107185

(51) Int. Cl. G09G 5/00

(52) U.S. Cl. 345/212; 345/87

(57) ABSTRACT

A driving circuit for a liquid crystal display device of at least one embodiment of the present invention includes: a scanning signal line driving circuit turning on switching elements in each horizontal scanning period; a video signal line driving circuit outputting a video signal whose polarity is reversed in synchronization with the each horizontal scanning period, the polarity being reversed in a subsequent horizontal scanning period assigned to one row from the polarity in a preceding horizontal scanning period assigned to the one row, the subsequent horizontal scanning period and the preceding horizontal scanning period being two successive horizontal scanning periods; a reference voltage generating section connected to the video signal line driving circuit; and a storage capacitance electrode driving circuit outputting, to each of storage capacitance voltage supply lines, a voltage of the each storage capacitance voltage supply line, the voltage having a polarity reversed every frame, the reference voltage generating section being capable of supplying, as a reference supply voltage for each video signal line, any voltage in accordance with a polarity of each of pixel electrodes connected to each scanning signal line, the reference supply voltage being supplied to the video signal line driving circuit, for example, at a start of display.

### TECHNICAL FIELD

The present invention relates to a driving circuit for a liquid crystal display device which circuit is intended to improve display quality at the start and end of display in the liquid crystal display device including driving circuits such as a video signal line driving circuit and a scanning signal line driving circuit.

### BACKGROUND ART

Conventionally, in an active matrix liquid crystal display device, there has been employed a driving system in which a liquid crystal capacitance and a storage capacitance are used in combination. The following describes a liquid crystal display device with reference to FIG. 6 which is a block diagram schematically showing a configuration of a liquid crystal display device.

As shown in FIG. 6, a liquid crystal display device 10 includes a plurality of video signal lines 20, a plurality of scanning signal lines 22 which are orthogonal to the plurality of video signal lines 20, pixel TFTs (Thin Film Transistors) 30 as switching elements provided in the vicinity of respective intersections of the video signal lines 20 and the scanning signal lines 22, pixel electrodes 40 connected to the respective pixel TFTs 30, and a plurality of storage capacitance voltage supply lines 24 (CS: Capacity Storage) each of which is arranged to make a pair with one of the plurality of scanning signal lines 22 and to be parallel to the plurality of scanning signal lines 22.

The liquid crystal display device 10 further includes a common electrode 42 which is formed so as to be opposed to each of the pixel electrodes 40 via a liquid crystal layer 14. Moreover, to each of the storage capacitance voltage supply lines 24, a corresponding storage capacitance electrode 44 is connected.

Furthermore, the liquid crystal display device 10 includes a liquid crystal capacitance 32 formed between each of the pixel electrodes 40 and the common electrode 42, and a storage capacitance 34 formed between the pixel electrode 40 and a corresponding storage capacitance electrode 44.

The plurality of video signal lines 20 are connected to a video signal line driving circuit 52, while the plurality of scanning signal lines 22 are connected to a scanning signal line driving circuit 54. Further, the plurality of storage capacitance voltage supply lines 24 are connected to a storage capacitance electrode driving circuit 56.

(Patent Literature 1)

The foregoing driving system is described in, for example, Patent Literature 1 as described below. Concretely, Patent Literature 1 discloses a technique in which, for example, a storage capacitance electrode driving circuit is provided so that a voltage whose polarity is reversed every frame is supplied to storage capacitances on each signal line.

In this technique, a voltage of the storage capacitance voltage supply line 24 is shifted as appropriate so that an amplitude in each of the signal lines is decreased. This makes it possible to attain a liquid crystal display device that has a lower power consumption.

(Power-Up Period)

In the driving system, a voltage level of each circuit tends to be unstable in a power-up period, thereby causing a lateral bright streak line to be recognized.

For the purpose of solving this problem, there has been proposed a technique in which a defect caused by instability of the voltage level is suppressed.

(Patent Literature 2)

For example, Patent Literature 2 discloses three techniques as described below, as a method for providing a liquid crystal display device in which no lateral bright streak line is recognized when a power supply is turned on.

The three techniques are:

1) a technique in which a common reference supply voltage is supplied to all storage capacitance voltage supply lines for a predetermined period after a power supply is turned on;

2) a technique in which, a predetermined period before cutting power supply, all pixel switching elements are turned on, and a common voltage is applied to all video signal lines;

3) a technique in which, when a power supply is turned on or power supply is cut, the same voltage as a voltage of a common electrode is applied to all video signal lines for a predetermined period by use of a control signal so as to turn on all pixel switching elements; and the like technique.

Patent Literature 1

Japanese Patent Application Publication, Tokukai, No. 2001-255851 A (Publication Date: Sep. 21, 2001)

Patent Literature 2

Japanese Patent Application Publication, Tokukai, No. 2005-49849 A (Publication Date: Feb. 24, 2005)

### SUMMARY OF INVENTION

(First Frame Period)

However, the above-described driving system does not solve a defect in display in a first frame period (period between B and C in FIG. 9 described later) after the start of display following the power-up period. Concretely, in the above-described driving system, a lateral bright streak line is still recognized in the first frame period. The following describes this problem.

(Operational Timing)

The following describes a driving in the above-described circuit, with reference to FIG. 7. FIG. 7 shows an operational timing in driving a liquid crystal display device 10.

As shown in FIG. 7, each of scanning signal lines 22 (GL1 to GLn) operates in a cycle of one frame. While selected, each of the scanning signal lines 22 is changed to have a voltage Vgh. Meanwhile, while unselected, each of the scanning signal lines 22 is kept at a voltage Vg1.

Similarly, each of storage capacitance voltage supply lines 24 (CS1 to CSn) operates in a cycle of one frame. A change in each of the storage capacitance voltage supply lines 24 occurs slightly after a fall in voltage (change from Vgh to Vg1) of its corresponding scanning signal line 22. That is, as shown in FIG. 7, the change in each of the storage capacitance voltage supply lines 24 occurs such that two values of voltages Vcsh and Vcs1 are alternately selected and supplied in accordance with a reverse polarity control signal.

(Voltage Waveform)

The following describes a waveform of a voltage which is applied to each of pixels 16, with reference to FIG. 8. FIG. 8 is a wave form chart of a voltage which is applied to each of the pixels 16.

As shown in FIG. 8, to the scanning signal line 22 (GL), a signal selected by the scanning signal line driving circuit 54 is supplied.

Concretely, while pixels 16 on one scanning signal line 22 are selected, a voltage of the pixels 16 is changed to Vgh. On the other hand, while the pixels 16 on one scanning signal line 22 are not selected, a voltage of the pixels 16 is kept at Vg1.

Further, a direct-current signal (constant voltage, Vcom) is outputted to a common electrode 42 from an external driving circuit.

(Pixel Electrode)

A voltage Vd of a pixel electrode 40 connected to a drain (drain electrode 30d) of a pixel TFT 30 changes in a cycle of one frame so that an output level of the voltage Vd changes, in turn, to a negative side and a positive side of an electric potential Vcom of the common electrode 42 at the center.

(Negative Frame)

The following describes, with reference to FIG. 8, a negative frame where the electric potential Vd of the pixel electrode 40 is on the negative side of the electric potential Vcom of the common electrode 42.

While the scanning signal line 22 is selected, the voltage Vd of each of pixel electrodes 40 on the scanning signal line 22 becomes a video signal voltage Vsl1 which is supplied via the video signal line 20 (SL).

Afterward, when the scanning signal line 22 (GL) turns unselected, the voltage of the scanning signal line 22 (GL) changes from Vgh to Vg1.

Then, due to a parasitic capacitance 36 (Cgd) between a gate and the drain of the pixel TFT 30, the voltage Vd of the pixel electrode 40 is reduced by Vgd from Vsl1.

Subsequently, when a voltage of a storage capacitance electrode 44 (CS) changes from Vcsh to Vcs1, the voltage Vd of the pixel electrode 40 is further reduced by Vcs due to an storage capacitance 34 (Ccs).

As a result, a voltage Vd1 is applied to a liquid crystal layer 14. The voltage Vd1 is a difference between the electric potential Vcom of the common electrode 42 and the electric potential Vd of the pixel electrode 40, i.e. Vd1=Vcom—(Vsl1−Vgd−Vcs). Hereinafter, the voltage Vd1 is referred to as a liquid crystal applied voltage Vd1.

Note that Vgd and Vcs described above are obtained by the following expressions.

Vgd=A(Vgh−Vg1)

Vcs=B(Vcsh−Vcs1)

Further, the above constants A and B are obtained by the following expressions.

A=Cgd/(Clc+Cgd+Ccs)

B=Ccs/(Clc+Cgd+Ccs)

(Positive Frame)

Similarly, with reference to FIG. 8, the following describes a positive frame where the electric potential Vd of the pixel electrode 40 is on a positive side of the electric potential Vcom of the common electrode 42.

While the scanning signal line 22 is selected, the voltage Vd of each of the pixel electrodes 40 on the scanning signal line 22 becomes a signal voltage Vsl2 which is supplied via the video signal line 20 (SL). Afterward, when the scanning signal line 22 (GL) turns unselected, the voltage of the scanning signal line 22 (GL) changes from Vgh to Vg1.

Then, due to the parasitic capacitance 36 (Cgd) between the gate and the drain of the pixel TFT 30, the voltage Vd of the pixel electrode 40 is reduced by Vgd from Vsl2.

Subsequently, when the voltage of the storage capacitance electrode 44 (CS) changes from Vcs1 to Vcsh, the voltage Vd of the pixel electrode 40 is further increased by Vcs due to the storage capacitance 34 (Ccs).

As a result, a voltage Vd1 is applied to the liquid crystal layer 14. The voltage Vd1 is a difference between the electric potential Vcom of the common electrode 42 and the electric potential Vd of the pixel electrode 40, i.e. Vd1=(Vsl2−Vgd+Vcs)−Vcom. Hereinafter, the voltage Vd1 is referred to as a liquid crystal applied voltage Vd1.

(Signal Timing)

The following describes a timing of a signal in the driving system, with reference to FIG. 9. FIG. 9 is a timing diagram showing a waveform of a voltage which is applied to each of the pixels 16 at the start of display in a conventional liquid crystal display device 10 operated in the above-mentioned configuration and driving system.

FIG. 9 shows waveforms of reference supply voltages (source driver reference voltage supply: Positive High level, Positive Low level, Negative High level, and Negative Low level) for a source driver (video signal line driving circuit 52), the electric potential Vcom of the common electrode 42, a video signal polarity in line reversal driving, a voltage of a video signal line, voltages of scanning signal lines 22 (GLn) and their corresponding storage capacitance voltage supply lines 24 (CSn), and liquid crystal applied voltages Vd1n which are applied to the pixels 16. The voltage of the video signal line is represented as “1+” in a case where a first line is positive, and as “1−” in a case where the first line is negative. Similarly, the voltage of the video signal line is represented as 2+/2−, . . . n+/n−.

As shown in FIG. 9, in the first frame period, the video signal lines 20 (SLn), the scanning signal lines 22 (GLn) and the like are started to be driven, and the storage capacitance voltage supply lines 24 (CSn) are also started to be driven.

In this first frame period, due to polarity reversal in the line reversal driving, alternate storage capacitance voltage supply lines 24 (CSn) corresponding to alternate scanning signal lines 22 have a voltage Vsch while the other alternate storage capacitance voltage supply lines 24 (CSn) corresponding to the other alternate scanning signal lines 22 have a voltage Vcs1.

(Change In Storage Capacitance Voltage Supply Line)

As shown in FIG. 9, all of the storage capacitance voltage supply lines 24 (CSn) are set at an identical supply voltage (Vcs1 level in FIG. 9) in the power-up period (between A and B).

In a case where the first line is positive in the first frame after the start of display, the voltages of the storage capacitance voltage supply lines 24 (CSn) only in odd lines change in the first frame period (between B and C) after the start of display.

That is, as shown in FIG. 9, in the odd lines, for example, in the first line, the voltage of the storage capacitance voltage supply line 24 (CSn) changes from Vcs1 of the power-up period to Vcsh.

Meanwhile, as shown in FIG. 9, in even lines, for example, in a second line, the voltage of the storage capacitance voltage supply line 24 (CSn) does not change but stays at Vcs1 of the power-up period even in the first frame period. That is, in the even lines, the voltages of the storage capacitance voltage supply lines 24 (CSn) do not change in the first frame period.

As described above, in the first frame period after the start of display, the voltages of some of the storage capacitance voltage supply lines 24 (CSn) change and the voltages of the others of the storage capacitance voltage supply lines 24 (CSn) do not change, depending on each scanning signal line 22. That is, in the first frame period after the start of display, the voltages of the storage capacitance voltage supply lines 24 (CSn) in the odd lines change, and the voltages of the storage capacitance voltage supply lines 24 (CSn) in the even lines do not change (see dotted ellipses in FIG. 9). This causes a lateral streak. The following describes the cause of the lateral streak.

(Cause of Lateral Streak)

In the lines where the voltages of the storage capacitance voltage supply lines 24 (CSn) change from Vcs1 to Vcsh, the change causes the liquid crystal applied voltages Vd1 to be shifted to Vd1n which is a target value for the individual lines. That is, a desired liquid crystal applied voltage Vd1 can be obtained.

However, in the lines, for example, the second line, where the voltages of the storage capacitance voltage supply lines 24 (CSn) do not change, the liquid crystal applied voltages Vd1 are not shifted to Vd1n which is the target value but stay at Vd1n′.

As a result, for example, in the first frame period, the alternate scanning signal lines 22 have a liquid crystal applied voltage Vd1 while the other alternate scanning signal lines 22 have another different liquid crystal applied voltage Vd1. This causes a lateral bright streak line to be recognized.

Further, such a lateral bright streak line occurs not only in the first frame period at the start of display but also in a last frame period at the end of display.

The present invention is attained in view of the foregoing problem, and an object of the present invention is to provide a driving circuit for a liquid crystal display device, which driving circuit can prevent generation of a lateral bright streak line in a first frame period at the start of display and in a last frame period at the end of display by a slight increase of a circuit.

A driving circuit for a liquid crystal display device of the present invention, to attain the object, includes a plurality of rows each including: (a) a scanning signal line; (b) switching elements turned on/off by the scanning signal line; (c) pixel electrodes each connected to a first end of corresponding one of the switching elements; and (d) a storage capacitance voltage supply line for forming a storage capacitance; and video signal lines each connected to a second end of corresponding one of the switching elements in each of the plurality of rows. The driving circuit includes: a scanning signal line driving circuit outputting a scanning signal in each horizontal scanning period sequentially assigned to the each row, the scanning signal for turning on the switching elements in the each row; a video signal line driving circuit outputting a video signal whose polarity is reversed in synchronization with the each horizontal scanning period assigned to the each row, the polarity being reversed in a subsequent horizontal scanning period assigned to one row from the polarity in a preceding horizontal scanning period assigned to the one row, the subsequent horizontal scanning period and the preceding horizontal scanning period being two successive horizontal scanning periods; a reference voltage generating section connected to the video signal line driving circuit; and a storage capacitance electrode driving circuit outputting, to each of the storage capacitance voltage supply lines, a voltage of the each storage capacitance voltage supply line, the voltage having a polarity reversed every frame, the reference voltage generating section being capable of supplying, as a reference supply voltage for each of the video signal lines, any voltage in accordance with a polarity of each of the pixel electrodes connected to each scanning signal line, the reference supply voltage being supplied to the video signal line driving circuit (i) in a first frame period at a start of display, (ii) in a last frame period at an end of display, or (iii) both in the first frame period at the start of display and in the last frame period at the end of display.

A so-called active matrix liquid crystal display device employs a driving system in which a storage capacitance is used in combination with a liquid crystal capacitance.

In a case where such a driving system is employed, as described above, in the first frame period at the start of display and in the last frame period at the end of display, the voltage of the storage capacitance voltage supply line may cause a lateral bright streak line to be recognized. The bright line is likely to be recognized particularly as a white bright line in a case where full black display is performed at the start of display, for example, in a normally black liquid crystal display device.

However, the foregoing configuration makes it possible to supply, as the reference supply voltage for the video signal line, the any voltage in accordance with the polarity of the pixel electrode connected to the scanning signal line in the first frame period at the start of display and the like. Therefore, control of the reference supply voltage for the video signal line can prevent variation in liquid crystal applied voltages caused by a change in voltage of the storage capacitance.

Further, the supply of the any voltage as the reference supply voltage for the video signal line can be attained in a simple circuit.

Therefore, the foregoing configuration makes it possible to provide the driving circuit for the liquid crystal display device capable of preventing occurrence of a lateral bright streak line in the first frame period at the start of display and in the last frame period at the end of display, by only a slight increase of the circuit.

It is preferable to arrange the driving circuit for the liquid crystal display device of the present invention such that the reference voltage generating section be capable of supplying the any voltage as the reference supply voltage only in the first frame period at the start of display.

It is preferable to arrange the driving circuit for the liquid crystal display device of the present invention such that the reference voltage generating section be capable of supplying the any voltage as the reference supply voltage only in the last frame period at the end of display.

In the first frame period at the start of display and in the last frame period at the end of display, variation in pixel voltages is likely to occur due to the change in voltage of the storage capacitance. However, the foregoing configuration makes it possible to effectively prevent occurrence of a lateral bright streak line in the first and last frame periods.

It is preferable to arrange the driving circuit for the liquid crystal display device of the present invention such that the reference voltage generating section be capable of supplying a plurality of different voltages as the reference supply voltage for the each video signal line; and the reference voltage generating section include a selecting circuit capable of selecting one reference supply voltage from among the plurality of different voltages.

The foregoing configuration makes it possible to set the plurality of different voltages as the reference supply voltage, and is provided with the selecting circuit for selecting one reference supply voltage from among the plurality of different voltages. This makes it possible to effectively and easily prevent occurrence of a lateral bright streak line.

In the driving circuit for the liquid crystal display device of the present invention, the reference voltage generating section includes a digital-to-analog converting circuit, and an amplifier connected to the digital-to-analog converting circuit; and the selecting circuit is provided on an input side of the digital-to-analog converting circuit.

According to the foregoing configuration, the selecting circuit is provided in a position preceding the digital-to-analog converting circuit and the amplifier.

As a result, it is not necessary to provide the digital-to-analog converting circuit and the amplifier for every reference voltage. This makes it possible to reduce a size of a circuit and the number of components of the circuit.

Further, in the driving circuit for the liquid crystal display device of the present invention, the reference voltage generating section includes a digital-to-analog converting circuit, and an amplifier connected to the digital-to-analog converting circuit; and the selecting circuit is provided on an output side of the amplifier.

According to the foregoing configuration, the selecting circuit can be provided to the output section where each of the reference voltages has already passed through the digital-to-analog converting circuit and the amplifier.

As a result, each one of the reference voltages has a digital-to-analog converting circuit and an amplifier each dedicated to the one reference voltage. This allows stable outputs of the reference voltages.

It is preferable to arrange the driving circuit for the liquid crystal display device of the present invention such that the reference supply voltage be set so as to compensate a difference between the scanning signal lines, the difference occurring in influence of the voltage of the each storage capacitance voltage supply line on an electric potential of the each pixel electrode.

The foregoing configuration makes it possible to drive the liquid crystal display device such that, to all of the pixel electrodes connected to the scanning signal lines, a normal liquid crystal applied voltage is applied at the start and end of display. This makes it unlikely to recognize a lateral bright streak line caused by application of a different liquid crystal applied voltage to each of the scanning signal lines.

It is preferable to arrange the driving circuit for the liquid crystal display device of the present invention such that the liquid crystal display device further include: a common electrode formed so as to be opposed to the each pixel electrode; and a liquid crystal layer provided between the common electrode and the each pixel electrode, and the influence of the voltage of the each storage capacitance voltage supply line on the electric potential of the each pixel electrode be substantially equal to a value obtained by dividing (a) a product of a storage capacitance multiplied by a width of a variation range of the voltage of the each storage capacitance voltage supply line by (b) a sum of a liquid crystal capacitance formed in the liquid crystal layer, a parasitic capacitance formed between the each scanning signal line and the each pixel electrode connected to the each scanning signal line, and the storage capacitance.

As described above, the foregoing configuration makes it possible to more reliably reduce a variation, caused by the voltage of the storage capacitance voltage supply line, between a liquid crystal applied voltage of one row and a liquid crystal applied voltage of another row.

As described above, the driving circuit for the liquid crystal display device of the present invention includes: a scanning signal line driving circuit outputting a scanning signal in each horizontal scanning period sequentially assigned to the each row, the scanning signal for turning on the switching elements in the each row; a video signal line driving circuit outputting a video signal whose polarity is reversed in synchronization with the each horizontal scanning period assigned to the each row, the polarity being reversed in a subsequent horizontal scanning period assigned to one row from the polarity in a preceding horizontal scanning period assigned to the one row, the subsequent horizontal scanning period and the preceding horizontal scanning period being two successive horizontal scanning periods; a reference voltage generating section connected to the video signal line driving circuit; and a storage capacitance electrode driving circuit outputting, to each of the storage capacitance voltage supply lines, a voltage of the each storage capacitance voltage supply line, the voltage having a polarity reversed every frame, the reference voltage generating section is capable of supplying, as a reference supply voltage for each of the video signal lines, any voltage in accordance with a polarity of each of the pixel electrodes connected to each scanning signal line, the reference supply voltage being supplied to the video signal line driving circuit (i) in a first frame period at a start of display, (ii) in a last frame period at an end of display, or (iii) both in the first frame period at the start of display and in the last frame period at the end of display.

The foregoing configuration makes it possible to provide a driving circuit for a liquid crystal display device capable of preventing occurrence of a lateral bright streak line in the first frame period at the start of display and in the last frame period at the end of display, by only a slight increase of the circuit.

### BRIEF DESCRIPTION OF DRAWINGS

FIG. 1

FIG. 1 is a circuit diagram showing a detailed configuration of a pixel, according to an embodiment of the present invention.

FIG. 2

FIG. 2 is a circuit diagram showing a detailed configuration of a storage capacitance electrode driving circuit, according to an embodiment of the present invention.

FIG. 3

FIG. 3 is a wave form chart of a voltage which is applied to each pixel at the start of display, according to an embodiment of the present invention.

FIG. 4

FIG. 4 is a block diagram schematically showing configurations of a source driver and a source driver reference voltage generating section, according to an embodiment of the present invention.

FIG. 5

FIG. 5 is a block diagram schematically showing configurations of a source driver and a source driver reference voltage generating section, according to another embodiment of the present invention.

FIG. 6

FIG. 6 is a block diagram schematically showing a configuration of a liquid crystal display device.

FIG. 7

FIG. 7 shows an operational timing in driving a liquid crystal display device.

FIG. 8

FIG. 8 is a wave form chart of a voltage which is applied to a pixel of a liquid crystal display device.

FIG. 9

FIG. 9 is a wave form chart of a voltage which is applied to each pixel at the start of display, according to a conventional technique.

FIG. 10

FIG. 10 is a block diagram schematically showing configurations of a source driver and a source driver reference voltage generating section, according to a conventional technique.

### REFERENCE SIGNS LIST

10: Liquid Crystal Display Device

20: Video Signal Line

22: Scanning Signal Line

24: Storage Capacitance Voltage Supply Line

30: Pixel TFT (Switching Element)

40: Pixel Electrode

50: Driving Circuit

52: Video Signal Line Driving Circuit

54: Scanning Signal Line Driving Circuit

56: Storage Capacitance Electrode Driving Circuit

70: Reference Voltage Generating Section

86: Selecting Circuit

### Description of Embodiment

### First Embodiment

The following describes an embodiment of the present invention with reference to drawings.

(Configuration of Liquid Crystal Display Device)

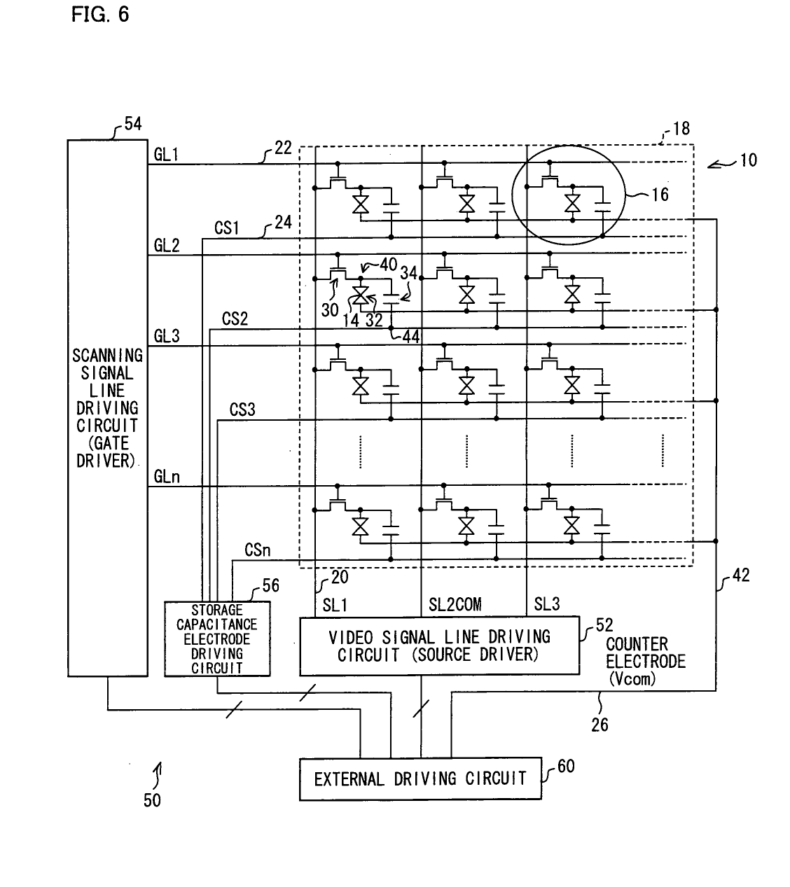

A liquid crystal display device 10 of the present invention has the substantially same configuration as the liquid crystal display device 10 previously described with reference to FIG. 6.

That is, the liquid crystal display device 10 of the present invention is configured as a so-called active matrix liquid crystal display device 10, and includes a plurality of pixels 16 provided in a grid-like pattern (in a matrix form). Further, each of the pixels 16 includes a pixel TFT (Thin Film Transistor) 30 provided as a switching element.

Between pixels 16 provided in the grid-like pattern, a plurality of video signal lines 20 and a plurality of scanning signal lines 22 which are orthogonal to each other are provided. Further, the liquid crystal display device 10 includes a plurality of storage capacitance voltage supply lines 24 each provided so as to make a pair with a corresponding scanning signal line 22, and so as to be parallel to the plurality of scanning signal lines 22.

(Pixel)

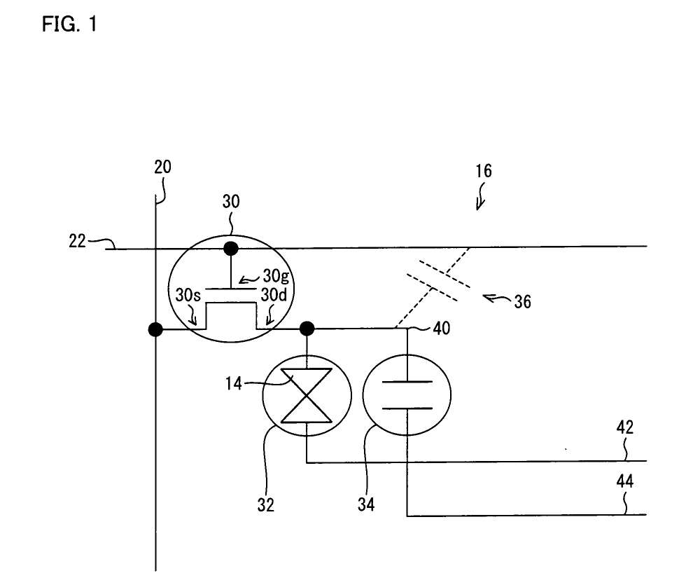

The following describes one of the pixels 16 with reference to FIG. 1. FIG. 1 is an enlarged view of the pixel 16 shown in FIG. 6, and an equivalent circuit diagram of the pixel 16.

The pixel 16 is substantially an area surrounded by adjacent video signal lines 20 and adjacent scanning signal lines 22. The pixel 16 mainly includes a pixel TFT 30 as a switching element provided at an intersection of the video signal line 20 and the scanning signal line 22, a pixel electrode 40, a common electrode 42 provided so as to be opposed to the pixel electrode 40, a liquid crystal layer 14 provided between the pixel electrode 40 and the common electrode 42, and a storage capacitance electrode 44.

To the video signal line 20, a source electrode 30s of the pixel TFT 30 is connected. To the scanning signal line 22, a gate electrode 30g of the pixel TFT 30 is connected. Further, to the pixel electrode 40, a drain electrode 30d of the pixel TFT 30 is connected.

(Capacitance)

In the pixel 16, mainly three types of capacitances are formed. That is, a liquid crystal capacitance 32 (Clc), a storage capacitance 34 (Ccs), and a parasitic capacitance 36 (Cgd) are formed. The liquid crystal capacitance 32 (Clc) is formed via the liquid crystal layer 14 between the pixel electrode 40 and the common electrode 42, while the storage capacitance 34 (Ccs) is formed between the pixel electrode 40 and the storage capacitance electrode 44. Further, the parasitic capacitance 36 (Cgd) is formed between the pixel electrode 40 and a scanning signal line 22 adjacent to the pixel electrode 40.

Note that each common electrode 42 is connected to a single common electrode line 26. Therefore, the common electrodes 42 have an identical electric potential.

Further, a set of storage capacitance electrodes 44 on a single line (row) is connected to its corresponding storage capacitance voltage supply line 24.

(Driving Circuit)

As shown in FIG. 6, the liquid crystal display device 10 includes a driving circuit 50. The driving circuit 50 is provided in a section on the periphery of a pixel area 18 where the plurality of pixels 16 are provided in a matrix form.

Concretely, the section on the periphery of the pixel area 18 includes a video signal line driving circuit 52 (source driver) to which the video signal lines 20 are connected, a scanning signal line driving circuit 54 (gate driver) to which the scanning signal lines 22 are connected, and a storage capacitance electrode driving circuit 56 to which the storage capacitance voltage supply lines 24 are connected.

The section on the periphery of the pixel area 18 also includes an external driving circuit 60 to which the driving circuits (the video signal line driving circuit 52, the scanning signal line driving circuit 54, and the storage capacitance electrode driving circuit 56), and the common electrode line 26 are connected. The external driving circuit 60 generates a video signal, a control signal, and various supply voltages.

The driving circuits (the video signal line driving circuit 52, the scanning signal line driving circuit 54, and the storage capacitance electrode driving circuit 56), and the external driving circuit 60 may be disposed on one of glass substrates which sandwich the liquid crystal layer 14, mounted on one of the glass substrates, or disposed outside the liquid crystal display device 10.

(Driving System)

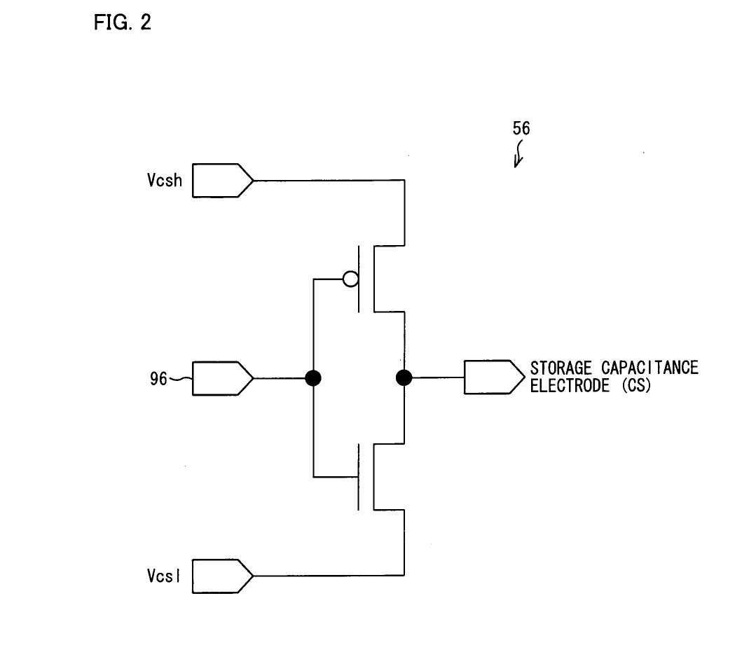

The following describes the storage capacitance electrode driving circuit 56 with reference to FIG. 2. FIG. 2 is a circuit diagram showing a detailed configuration of the storage capacitance electrode driving circuit 56. Note that this circuit diagram shows only a part of the storage capacitance electrode driving circuit 56, and this circuit shown in FIG. 2 is formed in each of the storage capacitance electrodes 44. The number of the storage capacitance voltage supply lines 24 is the same as the number of the scanning signal lines 22, and the storage capacitance voltage supply lines 24 are provided with the storage capacitance electrode driving circuits 56, respectively.

As shown in FIG. 2, the storage capacitance electrode driving circuit 56 includes a transistor for supplying a voltage Vcsh or a voltage Vcs1 to the storage capacitance voltage supply line 24. The transistor is switched between On and Off in accordance with a polarity reversal control signal 96 for controlling, in polarity inversion, a voltage of the storage capacitance voltage supply line 24 corresponding to the scanning signal line 22.

(Operational Timing)

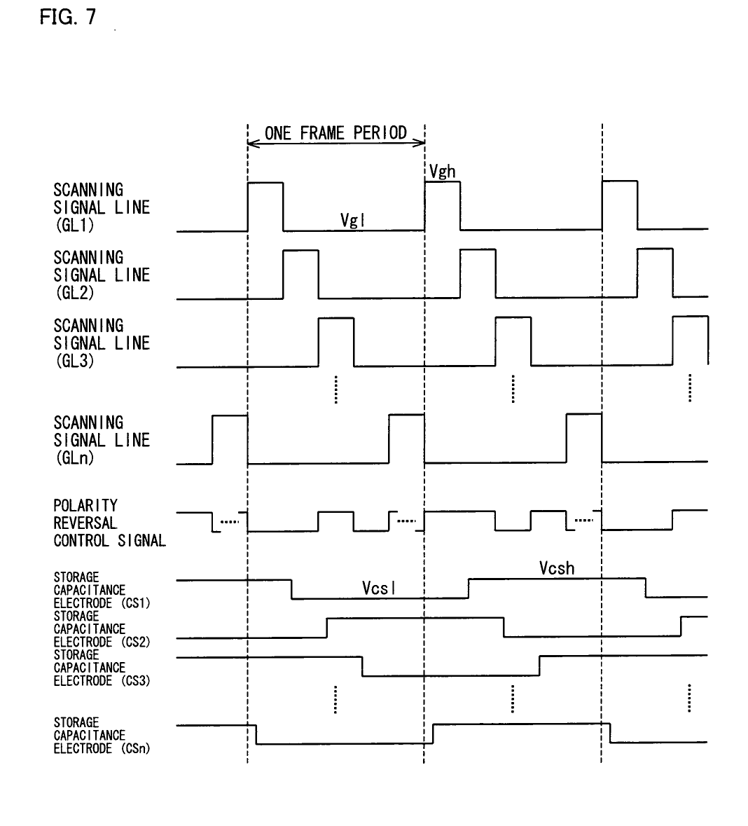

The following describes an operation of the liquid crystal display device 10 of the present embodiment. The operation of the liquid crystal display device 10 of the present embodiment is the same as the operation previously described with reference to FIG. 7.

(Selection and Non-selection of Scanning Signal Line)

The scanning signal line 22 operates in a cycle of one frame. The voltage of the scanning signal line 22 becomes Vgh that is a High voltage in a horizontal scanning period that is a selection period in which the scanning signal line 22 is selected, whereas the voltage of the scanning signal line 22 stays at Vg1 that is a Low voltage in a non-selection period in which the scanning signal line 22 is not selected.

(Reversal of Storage Capacitance Voltage Supply Line)

Similarly, a polarity of the storage capacitance voltage supply line 24 is reversed every frame. This change in the storage capacitance voltage supply line 24 occurs slightly after a fall of voltage (change from Vgh to Vg1) of a scanning signal line 22 corresponding to the storage capacitance voltage supply line 24. An electric potential of the storage capacitance voltage supply line 24 changes such that, as described above in relation to the storage capacitance electrode driving circuit 56 with reference to FIG. 2, either a voltage Vcsh that is a High voltage or a voltage Vcs1 that is a Low voltage is selected in accordance with the polarity reversal control signal which is inputted into the transistor provided in the storage capacitance electrode driving circuit 56.

(Voltage Wave Form Chart)

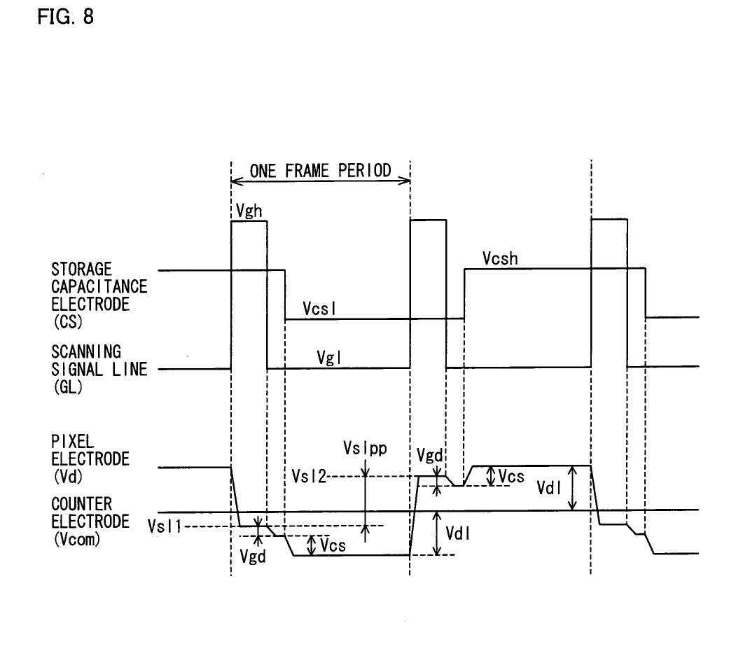

To the liquid crystal layer 14, a voltage called a liquid crystal applied voltage Vd1 is applied. This liquid crystal applied voltage Vd1 is determined as below. That is, as described above with reference to FIG. 8, the liquid crystal applied voltage Vd1 is determined mainly in accordance with a relation of the voltage of the scanning signal line 22, the voltage of the storage capacitance voltage supply line 24, a parasitic capacitance 36 between a gate and a drain, and the electric potential of the common electrode 42. The following concretely describes how the liquid crystal applied voltage Vd1 is determined.

(Scanning Signal Line)

As shown in FIG. 8, the voltage of the scanning signal line 22 (GL) becomes Vgh that is a High voltage when the pixels 16 on one scanning signal line 22 (GL) are selected, whereas the voltage of the scanning signal line 22 (GL) becomes Vg1 that is a Low voltage when the pixels 16 on one scanning signal line 22 (GL) are not selected.

(Common Electrode)

To the common electrode 42, the external driving circuit outputs a direct-current signal through the common electrode line 26.

(Pixel Electrode Vd)

The pixel electrode 40 connected to the drain of the pixel TFT 30 has an electric potential Vd (output level) that changes, in a cycle of one frame, alternately to a negative side and a positive side of an electric potential Vcom of the common electrode at the center. Accordingly, the liquid crystal applied voltage Vd1 that is applied to the liquid crystal layer 14 also changes every frame. On this account, the following describes the negative and positive sides separately.

(Negative Side)

The following describes a negative frame where the electric potential Vd of the pixel electrode 40 is on a negative side of the electric potential Vcom, with reference to FIG. 8.

In the negative frame, during a selection period in which the scanning signal line 22 is selected, the pixel electrodes 40 on this scanning signal line 22 are charged to a signal voltage Vsl1.

Then, when the selection period turns into a non-selection period in which the scanning signal line 22 is unselected, the voltage of each of the pixel electrodes 40 is reduced by Vgd from Vsl1 due to the parasitic capacitance 36 (Cgd) between the gate and the drain of the pixel TFT 30.

Subsequently, when a voltage of each of storage capacitance electrodes 44 changes from Vcsh to Vcs1, the voltage Vd of each of the pixel electrodes 40 is further reduced by Vcs from a value at the time of the non-selection period due to the storage capacitance 34 (Ccs).

As a result, the liquid crystal applied voltage Vd1 is expressed as: Vd1=Vcom−(Vsl1−Vgd−Vcs) as a difference between the pixel electrode Vd and the common electrode Vcom.

(Positive Side)

Similarly, with reference to FIG. 8, the following describes a positive frame where the electric potential Vd of the pixel electrode 40 is on a positive side of the electric potential Vcom.

In the positive frame, during the selection period where the scanning signal line 22 is selected, the pixel electrodes 40 on this scanning signal line 22 are charged to a signal voltage Vsl2.

Then, when the selection period turns into a non-selection period in which the scanning signal line 22 is unselected, the voltage of each of the pixel electrodes 40 is reduced by Vgd from Vsl2 due to the parasitic capacitance 36 (Cgd) between the gate and the drain of the pixel TFT 30.

Subsequently, when the voltage of each of the storage capacitance electrodes 44 changes from Vcs1 to Vcsh, the voltage Vd of each of the pixel electrodes 40 is increased by Vcs from a value at the time of the non-selection period due to the storage capacitance 34 (Ccs).

As a result, the liquid crystal applied voltage Vd1 is expressed as: Vd1=(Vsl2−Vgd+Vcs)−Vcom as a difference between the pixel electrode Vd and the common electrode Vcom.

(Present Invention)

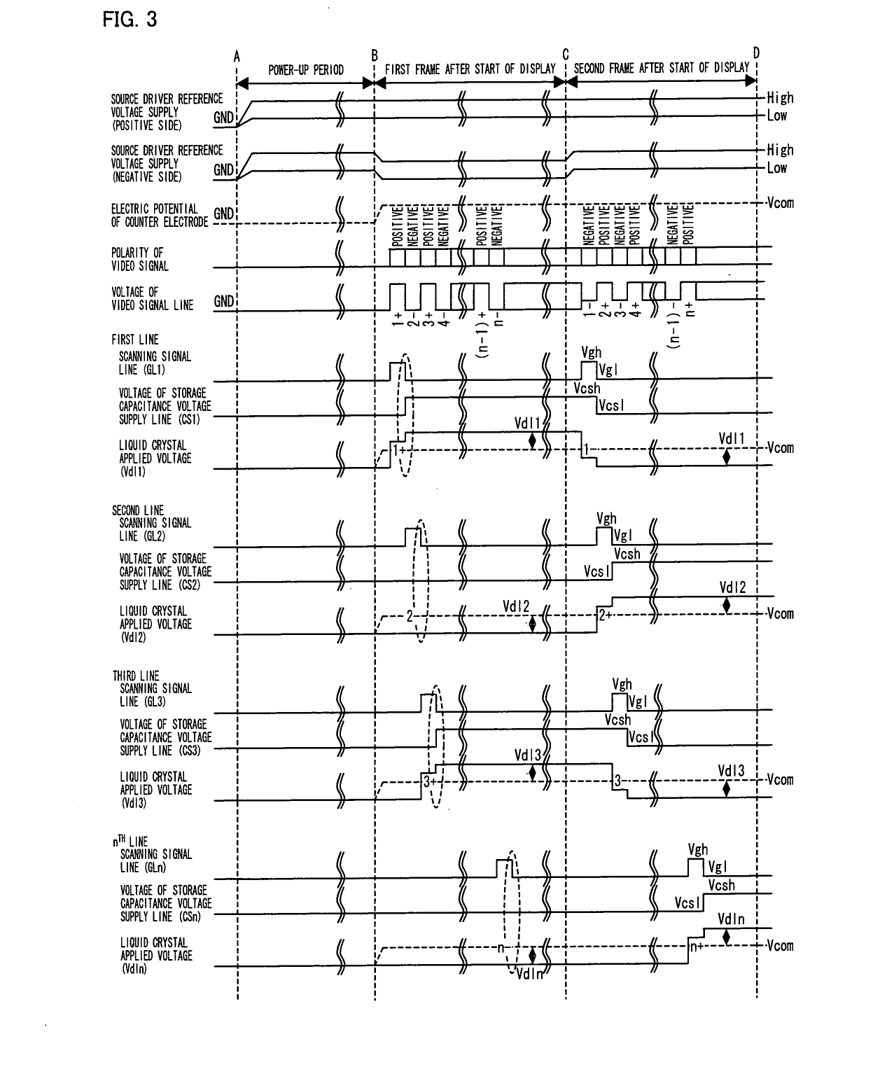

The following describes a voltage waveform in accordance with the present embodiment with reference to FIG. 3. FIG. 3 is a timing diagram showing a wave form chart of a voltage which is applied to each pixel at the start of display in accordance with an embodiment of the present invention.

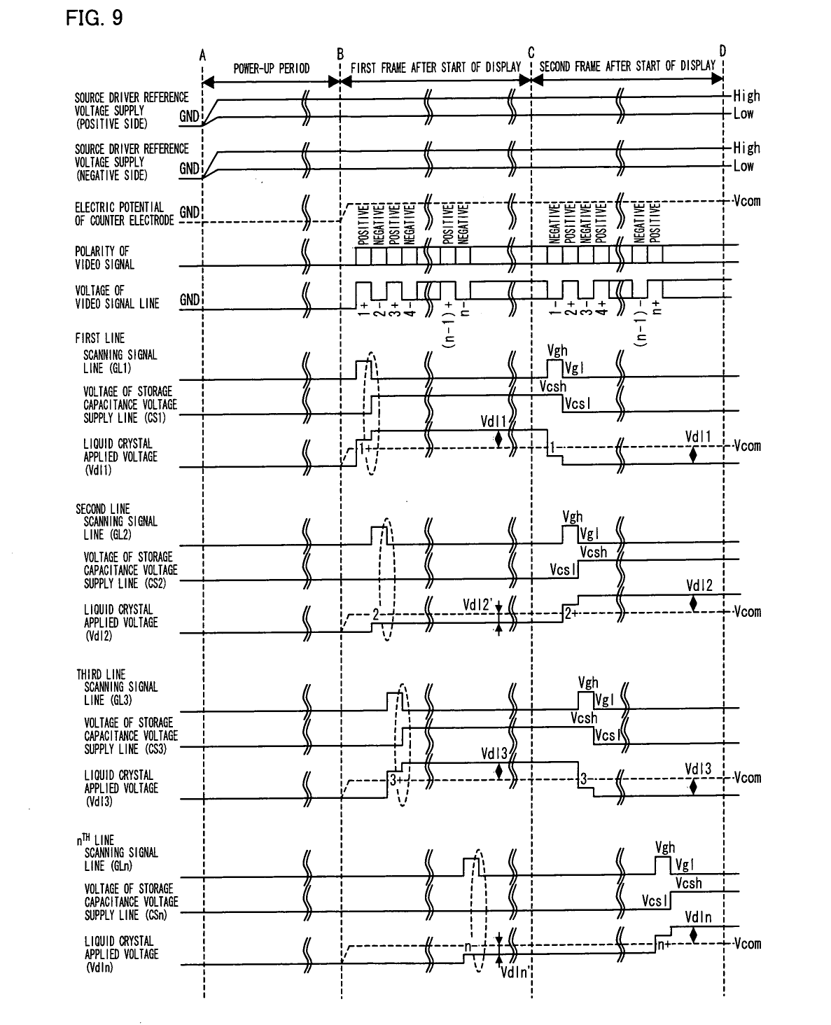

The voltage waveform in accordance with the present embodiment differs from the conventional voltage waveform described above with reference to FIG. 9 in that a reference supply voltage (a negative High level and a negative Low level) for a source driver (video signal line driving circuit 52) in a first frame (between B and C) after the start of display is controlled separately from a voltage during normal display.

In the conventional voltage waveform shown in FIG. 9, negative voltages of a reference voltage supply for a source driver (source driver reference voltage supply) in the first frame are the same as those in the power-up period and a second frame.

However, in the voltage waveform of the present embodiment, the source driver reference supply voltages in accordance with the present embodiment shown in FIG. 3 are different from those in the power-up period and the second frame period. Concretely, the source driver reference supply voltages are shifted to lower voltages.

Further, as described above, in the first frame, the source driver reference supply voltages are controlled separately from the voltages during normal display. This makes it possible to prevent occurrence of a problem that the liquid crystal applied voltages Vd1 vary depending on lines in the first frame. That is, it becomes possible to improve the problem that a bright line is produced as described above. That is, the problem is such that the bright line is produced, because the voltages of some of the storage capacitance voltage supply lines 24 (CSn) change and the voltages of the others of the storage capacitance voltage supply lines 24 (CSn) do not change depending on lines, and this causes a difference in the liquid crystal applied voltage Vd1 between the storage capacitance voltage supply lines 24 (CSn) whose voltages change and the storage capacitance voltage supply lines 24 (CSn) whose voltages do not change. The following describes how such a problem is solved.

Here, a second line is described as an example. In the first frame of the conventional voltage waveform, a voltage of the storage capacitance voltage supply line (CS2) does not change when the voltage of the scanning signal line 22 (GL2) falls. This is because the voltage of the storage capacitance voltage supply line (CS2) has been Vcs1 since the power-up period. Because the voltage of the storage capacitance voltage supply line (CS2) does not change on this account, the liquid crystal applied voltage Vd12 is not shifted. This causes difference in the liquid crystal applied voltage Vd1 between the second line and other lines.

Meanwhile, the voltage waveform of the present embodiment is the same as the conventional voltage waveform in that a voltage of a storage capacitance voltage supply line (CS2) does not change when a voltage of a scanning signal line 22 (GL2) falls. However, in the present embodiment, the source driver reference supply voltage is controlled, thereby controlling a voltage of a video signal line 20. This compensates the difference in the liquid crystal applied voltage Vd1 that occurs between the second line and other lines due to no change in the voltage of the storage capacitance voltage supply line (CS2) (see a dotted ellipse shown in FIG. 3).

This makes it possible to prevent the occurrence of the difference in the liquid crystal applied voltage Vd1 every line.

(Conclusion)

As described above, the present embodiment controls the source driver reference supply voltage (a negative High level and a negative Low level) in the first frame (between B and C) after the start of display, thereby adjusting the voltage of the video signal line in a line in which the voltage of the storage capacitance voltage supply line 24 (CSn) does not change. This allows the liquid crystal applied voltages Vd1 (effective values) of all lines to be identical with each other.

(Configuration of Conventional Source Driver (Video signal Line Driving Circuit) Etc.)

The following describes a source driver (video signal line driving circuit 52) and the like for the control described above.

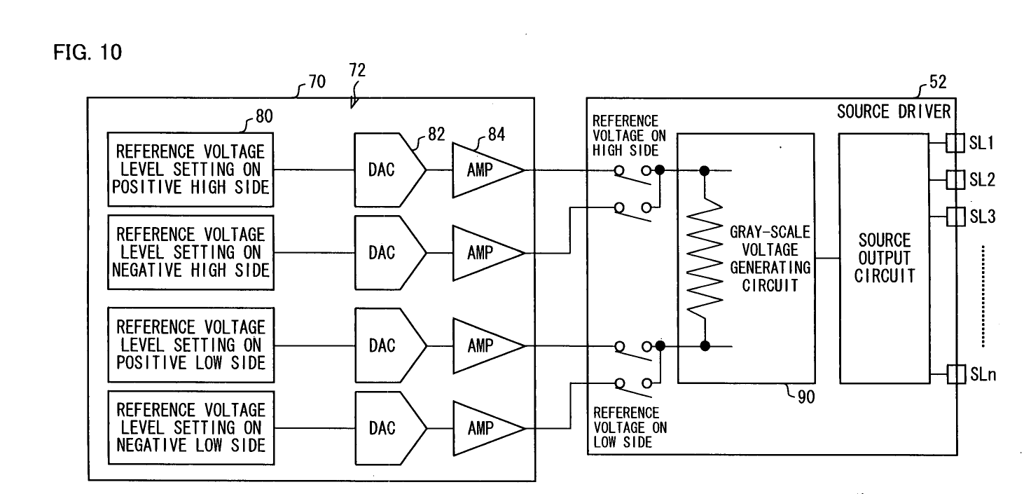

First, the following describes a conventional source driver 52 and a conventional reference voltage generating section (source driver reference voltage generating section 70) with reference to FIG. 10. FIG. 10 is a block diagram schematically showing configurations of the conventional source driver 52 and the conventional source driver reference voltage generating section 70.

(Source Driver Reference Voltage Generating Section)

As shown in FIG. 10, the source driver reference voltage generating section 70 includes a source driver reference voltage generating circuit 72. Into the source driver reference voltage generating circuit 72, respective level setting data 80 of a positive High level, a positive Low level, a negative High level, and a negative Low level are inputted. The source driver reference voltage generating circuit 72 also includes DAC (Digital to Analog Converter, digital-to-analog converting circuit) sections 82 and AMP (Amplifier) sections 84. Each of the DAC sections 82 outputs a voltage in accordance with corresponding level setting data 80.

(Source Driver)

The source driver reference voltage generating section 70 generates a reference supply voltage. The reference supply voltage is inputted into the source driver (video signal line driving circuit 52). The source driver 52 includes a gray-scale voltage generating circuit 90 including a ladder resistance section, and a source output circuit 92 which outputs a source signal voltage as video data generated by the gray-scale voltage generating circuit 90 to output terminals 94 (SLn).

(Configuration of Source Driver (Video Signal Line Driving Circuit) Etc. of Present Embodiment)

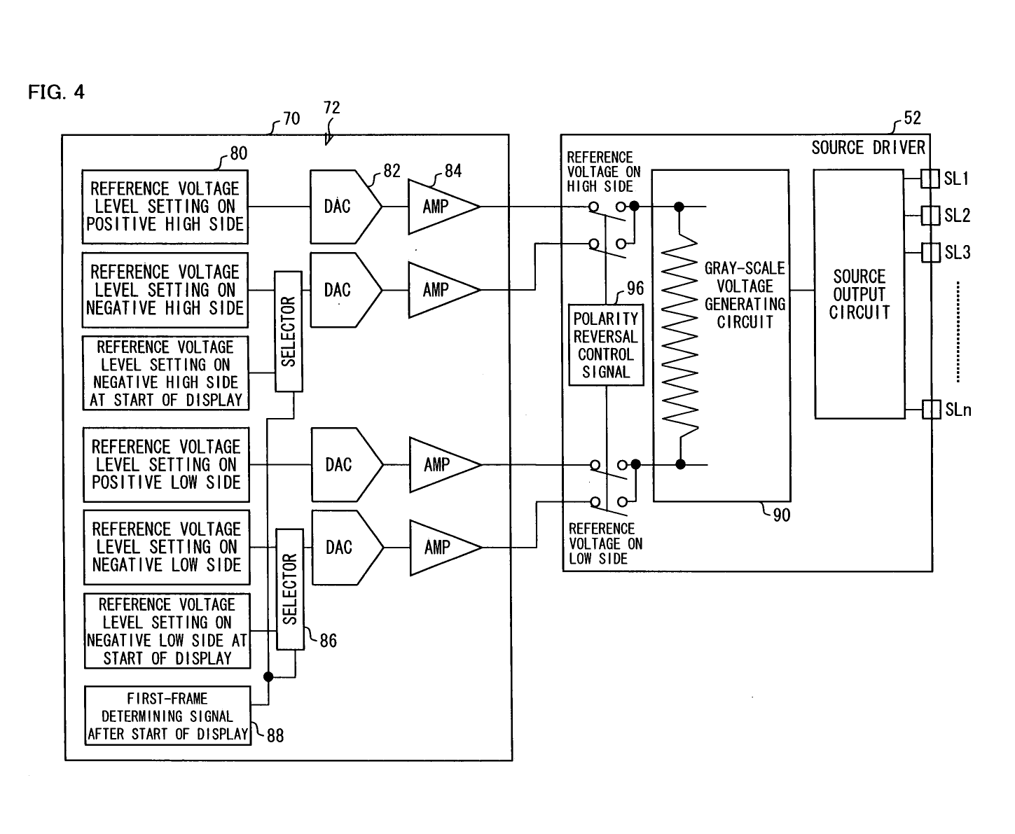

A source driver reference voltage generating section 70 of the present embodiment differs from the conventional source driver reference voltage generating section 70 in that the source driver reference voltage generating section 70 of the present embodiment additionally includes selecting circuits 86 for selecting a reference supply voltage. The following provides an explanation with reference to FIG. 4 which is a block diagram schematically showing configurations of a source driver (video signal line driving circuit 52) and the source driver reference voltage generating section 70 in accordance with an embodiment of the present invention.

As shown in FIG. 4, the source driver 52 of the present embodiment differs from the conventional source driver reference voltage generating section 70 in that the source driver reference voltage generating section 70 of the present embodiment additionally includes the selecting circuits 86 (SELECTOR). The selecting circuits 86 selects a reference supply voltage during normal display, and a reference supply voltage at the start of display with use of (i) data (level setting data 80) for setting respective levels of a negative High level and a negative Low level each at the start of display and (ii) a signal (first-frame determining signal 88) for determining a first frame at the start of display.

The source driver 52 of the present embodiment includes terminals for inputs from the source driver reference voltage generating section 70. The input terminals are switched in accordance with a polarity reversal control signal 96.

As described above, this configuration makes it possible to control the reference supply voltages (a negative High level and a negative Low level) for the source driver 52 in the first frame (between B and C) after the start of display separately from the voltage during normal display. This makes it possible to prevent a lateral bright streak line from being recognized.

### Second Embodiment

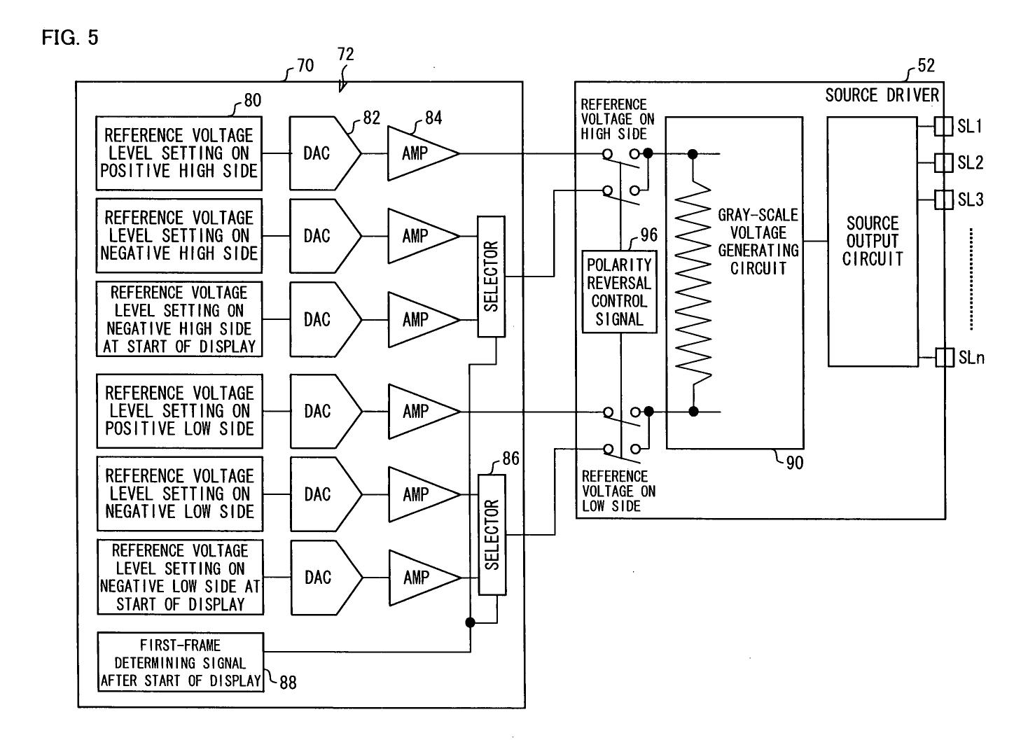

The following describes another embodiment of the present invention with reference to FIG. 5. FIG. 5 is a block diagram schematically showing configurations of a source driver 52 and a source driver reference voltage generating section 70 in accordance with the present embodiment.

Note that configurations other than what is described in the present embodiment are identical to those of First

Embodiment. Further, for convenience in description, identical reference signs are given to members having identical functions with the members indicated in the drawings of First Embodiment, and descriptions of such members are omitted here.

The source driver reference voltage generating section 70 of the present embodiment is different from the source driver reference voltage generating section 70 of First Embodiment in positions where selecting circuits 86 are provided.

That is, in First Embodiment, as shown in FIG. 4, selecting circuits 86 are provided at a stage prior to a stage where level setting data 80 are inputted into DAC sections 82. In other words, the selecting circuits 86 are provided to input sections for the DAC sections 82. This configuration makes it possible to reduce the number of components because it is not necessary to provide the DAC sections 82 and the AMP sections 84 for each reference voltage.

Meanwhile, in the present embodiment, DAC sections 82 are provided to output sections for AMP sections 84 in the source driver reference voltage generating section 70.

That is, into the DAC sections 82, respective level setting data 80 of a negative High level and a positive Low level at the start of display are directly inputted. The DAC sections 82 output voltages in accordance with the level setting data 80, respectively. The DAC sections 82 are connected to the AMP sections 84, respectively.

To the output sections of the AMP sections 84, the selecting circuits 86 each for selecting a reference supply voltage during normal display and a reference supply voltage at the start of display are provided. Each of the selecting circuits 86 selects a reference supply voltage according to a first-frame determining signal 88 which is a signal for determining a first frame at the start of display.

This configuration makes it easy to set a voltage at a level that is not used as the reference supply voltage during normal display. Further, this configuration also makes it possible to output a stable reference voltage.

(Other Signal Configuration, CSn=Vcsh)

The foregoing describes, as an example, a case where the voltage of the storage capacitance voltage supply line 24 (CSn) is at a Vcs1 level in the power-up period (between A and B). However, the same is also applicable to a case where the voltage of the storage capacitance voltage supply line 24 (CSn) is set at other supply voltage level in the power-up period. That is, for example, in a case where the voltage of the storage capacitance voltage supply line 24 (CSn) is at a Vcsh level in the power-up period (between A and B), the same effect as the above-described present embodiment can be attained by controlling source driver reference supply voltages on a positive side (a positive High level and a negative Low level) in a first frame (between B and C) after the start of display.

(At End of Display)

Further, the foregoing describes, as an example, a case at the start of display. However, an identical problem may also occur at the end of display.

Furthermore, at the end of display, the same driving as that at the start of display makes it possible to attain the same effect as the effect attained for the start of display such that occurrence of a lateral streak is prevented.

The present invention is not limited to the description of the embodiments above, but may be altered by a skilled person within the scope of the claims. An embodiment based on a proper combination of technical means disclosed in different embodiments is encompassed in the technical scope of the present invention.

### INDUSTRIAL APPLICABILITY

The present invention can prevent occurrence of a lateral streak. Therefore, the present invention is suitably applicable to a liquid crystal display device which is required to have a high display quality.

1. A driving circuit for a liquid crystal display device, comprising:
a plurality of rows each including:
(a) a scanning signal line;
(b) switching elements turned on/off by the scanning signal line;
(c) pixel electrodes each connected to a first end of corresponding one of the switching elements; and
(d) a storage capacitance voltage supply line for forming a storage capacitance; and
video signal lines each connected to a second end of corresponding one of the switching elements in each of the plurality of rows,
the driving circuit comprising:
a scanning signal line driving circuit outputting a scanning signal in each horizontal scanning period sequentially assigned to the each row, the scanning signal for turning on the switching elements in the each row;
a video signal line driving circuit outputting a video signal whose polarity is reversed in synchronization with the each horizontal scanning period assigned to the each row, the polarity being reversed in a subsequent horizontal scanning period assigned to one row from the polarity in a preceding horizontal scanning period assigned to the one row, the subsequent horizontal scanning period and the preceding horizontal scanning period being two successive horizontal scanning periods;
a reference voltage generating section connected to the video signal line driving circuit; and
a storage capacitance electrode driving circuit outputting, to each of the storage capacitance voltage supply lines, a voltage of the each storage capacitance voltage supply line, the voltage having a polarity reversed every frame,
the reference voltage generating section being capable of supplying, as a reference supply voltage for each of the video signal lines, any voltage in accordance with a polarity of each of the pixel electrodes connected to each scanning signal line, the reference supply voltage being supplied to the video signal line driving circuit (i) in a first frame period at a start of display, (ii) in a last frame period at an end of display, or (iii) both in the first frame period at the start of display and in the last frame period at the end of display.

2. The driving circuit for the liquid crystal display device as set forth in claim 1, wherein:
the reference voltage generating section is capable of supplying the any voltage as the reference supply voltage only in the first frame period at the start of display.

3. The driving circuit for the liquid crystal display device as set forth in claim 1, wherein:
the reference voltage generating section is capable of supplying the any voltage as the reference supply voltage only in the last frame period at the end of display.

4. The driving circuit for the liquid crystal display device as set forth in claim 1, wherein:
the reference voltage generating section is capable of supplying a plurality of different voltages as the reference supply voltage for the each video signal line; and
the reference voltage generating section includes a selecting circuit capable of selecting one reference supply voltage from among the plurality of different voltages.

5. The driving circuit for the liquid crystal display device as set forth in claim 4, wherein:
the reference voltage generating section includes a digital-to-analog converting circuit, and an amplifier connected to the digital-to-analog converting circuit; and
the selecting circuit is provided on an input side of the digital-to-analog converting circuit.

6. The driving circuit for the liquid crystal display device as set forth in claim 4, wherein:
the reference voltage generating section includes a digital-to-analog converting circuit, and an amplifier connected to the digital-to-analog converting circuit; and
the selecting circuit is provided on an output side of the amplifier.

7. The driving circuit for the liquid crystal display device as set forth in claim 1, wherein:
the reference supply voltage is set so as to compensate a difference between the scanning signal lines, the difference occurring in influence of the voltage of the each storage capacitance voltage supply line on an electric potential of the each pixel electrode.

8. The driving circuit for the liquid crystal display device as set forth in claim 7, wherein:
the liquid crystal display device further includes:
a common electrode formed so as to be opposed to the each pixel electrode; and
a liquid crystal layer provided between the common electrode and the each pixel electrode;
the influence of the voltage of the each storage capacitance voltage supply line on the electric potential of the each pixel electrode is substantially equal to a value obtained by dividing (a) a product of a storage capacitance multiplied by a width of a variation range of the voltage of the each storage capacitance voltage supply line by (b) a sum of a liquid crystal capacitance formed in the liquid crystal layer, a parasitic capacitance formed between the each scanning signal line and the each pixel electrode connected to the each scanning signal line, and the storage capacitance.
